(19) United States
(12) Patent Application Publication
(10) Pub. No.: US 2016/0356932 A1
(43) Pub. Date: Dec. 8, 2016

(54) Transparent Colored Light Filtering Screen Covers for Bright Light Emitting Electronic Devices

(71) Applicants: Maria Carlucci, New York, NY (US); Ronald Carlucci, Media, PA (US)

(72) Inventors: Maria Carlucci, New York, NY (US); Ronald Carlucci, Media, PA (US)

(21) Appl. No.: 15/168,195

(22) Filed: May 30, 2016

Related U.S. Application Data
(60) Provisional application No. 62/171,147, filed on Jun. 4, 2015.

(51) Int. Cl. G02B 5/22

(52) U.S. Cl. CPC G02B 5/223; G02B 5/226

(57) ABSTRACT

The invention relates to the technical field of screen protection, and in particular, relates to a screen cover piece, acting as a filter, of specific colors that will filter the bright light and bright glare emitted from the viewing screens of various electronic devices. A transparent color screen filter cover will be made of polyethylene terephthalate (PET) film, polyurethane film, and/or tempered glass with the composition of an Anti-Glare layer and a Hard Coating Layer. A gluing layer is applied on any side of the piece body or no gluing layer may be applied for other utility options. The transparent colored light filtering screen cover besides filtering out the irritating, bright light from electronic devices is also an aesthetically enhancing screen cover piece for such devices. The color spectrums being claimed for such transparent color tinted screen filter covers are: orange, red, rose, yellow, gold, green, brown, amber, copper and/or purple.

### CROSS-REFERENCE TO RELATED APPLICATIONS

This application claims the benefit of the Applicants' prior Provisional Application, No. 62/171,147, filed on Jun. 4, 2015.

### STATEMENT REGARDING FEDERALLY SPONSORED RESEARCH OR DEVELOPMENT

N/A

### BACKGROUND OF THE INVENTION:

1. Field of Invention

With the advances in technology, people use a variety of electronic devices (i.e.: smart phones, tablets, laptops, and computers) (hereinafter “said electronic devices”) on a frequently and continuous daily basis. Bright light that is emitted from these said electronic devices may cause a variety of personal discomforts, including but not limited to, sleeping difficulties, light sensitivity, and eye fatigue, as well as triggering and/or exacerbating headaches including migraine headaches.

The present invention relates to reducing these personal hazards through the use of a transparent colored light filtering screen cover that will be applied to these said electronic devices. In particular, the transparent colored light filtering screen cover will be comprised of the specific color choices of one or more of the following: orange, red, rose, yellow, gold, green, brown, amber, copper and/or purple. These specific colors will serve the function of reducing glare and filtering the irritating, bright lights emitted from said electronic devices.

Research has found that certain color overlays used and positioned onto bright light emitting sources, have decreased the eye light sensitivity and eye fatigue as a result of viewing and work time on said devices. Many persons are affected by eye light sensitivity which can become problematic with electronic device utilization. Certain color spectrums in eye glasses have been shown to be helpful to reduce light sensitivity exposure from bright light spectrums and bright light emitting sources affecting a broad range of individuals that may have medical conditions contributing to their light sensitivity, aging persons with eye conditions, or just occurrences. See also, Blackburn, M., et al., FL-41 Tint Improves Blink Frequency, Light Sensitivity, and Functional Limitations in Patients with Benign Essential Blepharospasm, PMCID: PMC2701948, NIHMSID: NIHMS114020. This study also surmised that it was reasonable that other colored-tinted lenses could be as effective as or more effective than rose-tinted lenses. Another study has shown that rose colored-tinted glasses reduced migraines in children who suffered from chronic migraines. Good, PA, et al., The Use of Tinted Glasses in Children Migraine, Headache, 1991 Sep; 31(8): 533-6; PMID: 1960058. Additionally, Dr. Andrew Hartwick from Ohio State University College of Optometry has shown through his research that subjects with mild traumatic brain injury experienced relief from photophobia through the use of orange-tinted glasses. One study has shown that light triggers migraines even in blind subject. Noseda R, Kainz V, Jakubowski M, et al, A Neural Mechanism for Exacerbation of Headache By Light. Nature Neuroscience, 2010;13(2):239-245. doi:10.1038/nn.2475; http://www.ncbi.nlm.nih.gov/pmc/articles/PMC2818758/. Moreover, the present transparent colored light filtering screen cover invention also serves as an aesthetic enhancement by personal choice of colors claimed herein for any said electronic device.

2. Description of the Related Art

There are no existing patents, to our knowledge, or products commercially available on the market that utilize the specific colors of orange, red, rose, yellow, gold, green, brown, amber, copper and/or purple to filter the bright light emitting from said electronic devices as described herein. There are current patents entitled that deal with “blue light” filters, however, all of the said filters are transparent and colorless: “Scrccn Protection Sheet With Function of Blue Light Filtering:” U.S. 20150212238 A1; “Blue Light Prevention Filtering Membrane:” CN 203825224 U;” “Hierarchical Structure of Blue-Light-Filtering Protective Film:” CN 204340325U; and “Screen Protection Film Capable of Filtering Blue Light and Preparation Method of Screen Protection Film:” CN 103448312A. Therefore, this current patent application differs from the prior art because none of the prior art utilizes any of the specific colors of orange, red, rose, yellow, gold, green, brown, amber, copper and/or purple in its application.

Currently on the market, there are screen protectors manufactured by iLLumiShield Blue Light for electronic devices that filter blue light but these screen protectors are clear in color. Additionally, there are a few other products that also block blue light but these products are either transparent or grey in color. Therefore, upon information and belief, there are no products with existing patents that utilize said specific colors of orange, red, rose, yellow, gold, green, brown, amber, copper and/or purple to filter the irritating bright light emitting from said electronic devices. Therefore, in view of the problems and/or limitations of the prior art, this product provides a solution to reducing a variety of hazards, including but not limited to, sleeping difficulties, light sensitivity, and eye fatigue, as well as triggering or exacerbating headaches, including migraine headaches, through the use of the specific colors of orange, red, rose, yellow, gold, green, brown, amber, copper and/or purple to in its application to filter and reduce any and all of the irritating, bright lights emitted from said electronic devices.

### SUMMARY OF THE INVENTION

Research shows that FL-41, certain rose and orange tinted glasses filter certain wavelengths that can relieve painful light sensitivity, protect from specific fluorescent light sources and aid persons with eye sensitivities such as intense blink frequency and benign essential blepharospasm. While fluorescent lights pulse faster than we can consciously see, our brain is still aware of the throbbing. More frequent use of harsh fluorescent and LCD/LED type bright viewing screens are becoming more problematic for persons with eye issues such as light sensitivity which can also be triggers for migraine headache sufferers and sleep problems. Preliminary research at the University of Utah suggests that specially tinted lenses may help some people with photophobia. Anecdotally, many photophobic patients prefer an FL-41 tint on their sunglasses instead of green or yellow. The FL-41 tint, which has a pinkish look to it, is a mixture of colors that blocks the blue-green wavelengths. However, certain other color spectrums such as orange, amber, yellow, and green may block other irritating wavelengths of bright lights such as violet light wavelengths or just dim down/reduce the bright, sharp emitting lights from electronic devices for certain persons.

According to researchers at the National Institute of Mental Health in Bethesda, Md., green light, to which the eye is most sensitive, has been proven to be most effective in treating seasonal affective disorder (“SAD”) patients. Winter Sun™ lenses have a light, golden-yellow tint with the highest UV protection available, so they can be worn indoors or out, at all times. The current invention of transparent colored light filtering screen covers comprised specific colors that may have the same positive visual enhancing and aesthetic effects as other products such as this type of sunglasses. Additionally, the Irlen technique is a worldwide technique of assessing, filtering out and producing these lenses (which they refer to as Irlen Filters). Another technique being used by some specialists in the area of ophthalmology (the study of visual-perception) is the color-imitor technique. Both of these techniques use tinted lenses, or filters, to filter out certain light frequencies in order to reduce information overload through the eyes. These lenses can also have a secondary effect of reducing hypersensitivity to bright light and also in helping to reduce some of the ‘interference’ (the visual-perceptual equivalent of ‘white noise’) that can happen with visual hypersensitivity and visual-perceptual problems.

The current invention is comprised of a transparent colored screen cover piece with specific colors that filters out the bright light and bright glare emitted from various electronic device viewing screens and it is simply a utilization of the aforementioned technology and products that exist in other uses currently to aid in decreasing various light sensitivity to the eyes and enhance product aesthetics. Currently, there are no commercially available products to our knowledge such as the current invention that utilizes the aforementioned technology in the selected color spectrums and for the various electronic devices as stated herein.

### DETAILED DESCRIPTION OF THE INVENTION

This invention relates to a transparent colored light filtering screen cover for any and all electronic devices that emit bright light. Said transparent colored light filter cover will reduce glare and eye fatigue. It should be understood that the specific embodiments are described herein only to explain the present invention and are not intended to limit the present invention.

The present invention is realized by the following technical solutions: The transparent colored light filtering screen covers will be designed to fit a variety of electronic devices. For small handheld devices, the filters may be manufactured as a thin film that can be attached to the electronic screen via an adhesive layer on the filter screen cover or by electrostatic attraction. If an adhesive is utilized, it will not leave a residue on the screen when the filter screen cover is removed.

The transparent colored light filtering screen covers may also be designed as a rigid sheet to fit over larger electronic screens such as computer monitors, televisions, etc. The filter screen covers will be designed to match the screen dimensions and if applicable, have the appropriate cut-outs for the selected electronic devices to provide a custom fit as an overlay. The filter screen covers may be framed to allow the assembly to be mechanically attached to the electronic device.

The transparent colored light filtering screen covers can be manufactured from different materials depending on the application. Films may be made of polyethylene terephthalate (PET), polyurethane and/or tempered glass. Rigid sheets may be made of polycarbonate, glass and/or tempered glass. The material used for the filter screen covers will be tinted to achieve the specific colors herein to block targeted bright light types. The filtering screen covers may also be treated to improve properties for anti-glare, anti-scratch, and oil/smudge resistance.

### BRIEF DESCRIPTION OF DRAWINGS

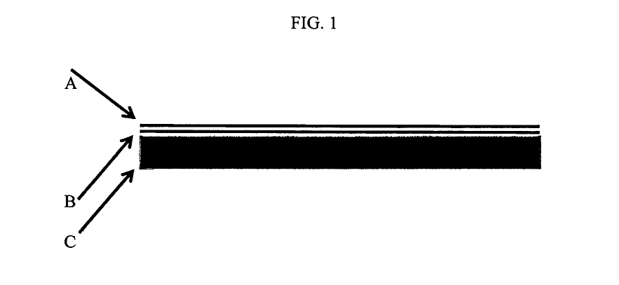

FIG. 1—side view of the Transparent Colored Light Filtering Screen Cover for Bright Light Emitting Electronic Devices
A—side view of the top layer of a Transparent Colored Light Filtering Screen Cover for Bright Light Emitting Electronic Device
B—side view of the adhesive layer of a Transparent Colored Light Filtering Screen Cover for Bright Light Emitting Electronic Device
C—an electronic device

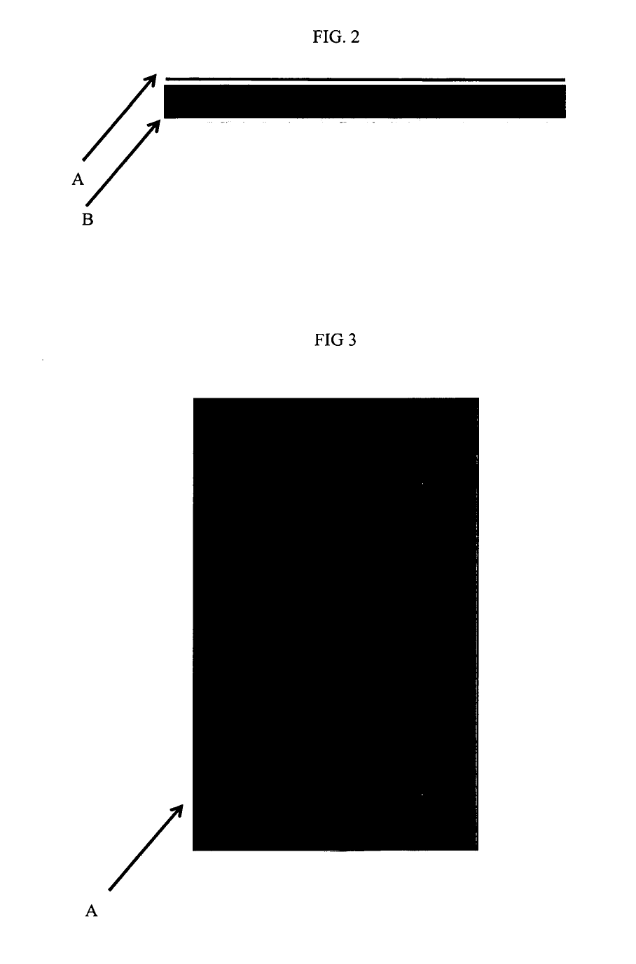

FIG. 2—side view of the Transparent Colored Light Filtering Screen Cover for Bright Light Emitting Electronic Devices
A—the side view of both layers of a Transparent Colored Light Filtering Screen Cover for Bright Light Emitting Electronic Device
B—an electronic device

FIG. 3—front view of the Transparent Colored Light Filtering Screen Cover for Bright Light Emitting Electronic Devices
A—the front view of a Transparent Colored Light Filtering Screen Cover for Bright Light Emitting Electronic Device

1. We claim a transparent colored light filtering screen covers for bright light emitting electronic devices comprising of: a film of either polyethylene terephthalate (PET), polyurethane, or tempered glass to be applied to the screen of any electronic device, including cellular phones, smart phones, tablets, computer screens, monitors, and LCD/LED type televisions.

2. The transparent colored light filtering screen cover for bright light emitting electronic devices according to claim 1, characterized in that: further comprising of colors of orange, red, rose, yellow, gold, green, brown, amber, copper, and/or purple.

3. The transparent colored light filtering screen cover for bright light emitting electronic devices of claim 1, wherein said screen cover is cut to a shape that matches the display surface which it is meant to be applied.

4. The transparent colored light filtering screen cover for bright light emitting electronic devices of claim 1, wherein said screen cover is contoured to correspond with the surface profile of an electronic device or a screen of an electronic device.

5. The transparent colored light filtering screen cover for bright light emitting electronic devices according to claim 1, wherein it will reduce the bright emitting light and glare from electronic devices and reduce eye fatigue, eye light sensitivity, and other irritating eye and personal discomfort issues resulting from continual use of said electronic devices.

6. The transparent colored light filtering screen cover for bright light emitting electronic devices of claim 1, wherein said adhesive, if needed for select devices or if adhesive is not needed then it will be applied by electrostatic attraction, comprises of an adhesive that is capable of adhering the protective film to a screen display surface with minimal or no external pressure.

7. The transparent colored light filtering screen cover for bright light emitting electronic devices of claim 1, wherein the first layer comprises of either polycaprolactone aliphatic polyurethane or polyethylene terephthalate and wherein said second layer comprises a material selected from the group consisting of acrylic, polystryrene plastics, or polyethylene terephthalate, and wherein the said first layer bottom surface is attached to said second layer top surface and said adhesive, if needed for select devices or if adhesive is not needed then it will be applied by electrostatic attraction, is provided on said second layer bottom surface.

8. The transparent colored light filtering screen cover for bright light emitting electronic devices of claim 1, wherein said screen cover serves as an aesthetic enhancement by personal choice of colors claimed herein for any said electronic device.
